(19) United States
(12) Patent Application Publication
(10) Pub. No.: US 2004/0092158 A1
(43) Pub. Date: May 13, 2004

(54) Power outlet with support element

(76) Inventor: Chao Chuan Chien, Hsin-Chuang City (TW)

Correspondence Address: QUINTERO LAW OFFICE, 1617 BROADWAY, 3RD FLOOR, SANTA MONICA, CA, 90404, US

(21) Appl. No.: 10/293,673

(22) Filed: Nov. 13, 2002

(51) Int. Cl. H01R 11/00

(52) U.S. Cl. 439/505

(57) ABSTRACT

A power outlet with support, comprising: a male plug for coupling to a power source; at least one wire having at least two conductive wires, wherein one end of the wire is connected to said male plug; at least one outlet apparatus, wherein each outlet apparatus comprises a outlet and a housing that has a mating structure on a lower surface, one end of the outlet apparatus connected to another end of the wire and another end of the outlet apparatus connected to another wire; and at least one support is configured in response to said mating structure of said housing for supporting and fixing said power outlet.

### FIELD OF THE INVENTION

The present invention relates generally to the field of power outlet and, more particularly, to outlet apparatus having a support for supporting and fixing and having ability to waterproof and dustproof.

### BACKGROUND OF THE INVENTION

Generally speaking, an outdoor power outlet that is used in a garden or a yard in accordance with the prior art has at least one outlet. The outlet is positioned in the garden or the yard regardless of rainy day or sunny day. However, the outdoor power outlet in accordance with the prior art is unable to fix and the dust or the water could intrude into the outlet easily, as a result, the conductive of the outlet will become badly or short circuit that could cause danger. Therefore, an outdoor power outlet with a cover and/or a switch is needed for protecting the user who uses the power outdoor.

### SUMMARY OF THE INVENTION

It is an object of the present invention to provide a power outlet with support for protecting the outlet and providing security of power.

In accordance with one embodiment of the invention, a power outlet with support is provided comprising: a male plug for coupling to a power source; at least one wire having at least two conductive wires, wherein one end of the wire is connected to said male plug; at least one outlet apparatus, wherein each outlet apparatus comprises a outlet and a housing that has a mating structure on a lower surface, one end of the outlet apparatus connected to another end of the wire and another end of the outlet apparatus connected to another wire; and at least one support is configured in response to said mating structure of said housing for supporting and fixing said power outlet.

### BRIEF DESCRIPTION OF THE DRAWINGS

The novel features believed characteristic of the invention are set forth with particularity in the appended claims. The invention itself, however, as well as a preferred mode of use, further objectives and advantages thereof, will be best understood by reference to the following detailed description when read in conjunction with the accompanying drawings, wherein:

FIG. 1 depicts an assembly view of a power outlet with support in accordance with one embodiment of the present invention.

FIG. 2 depicts an assembly view of a power outlet that has a hook on the top surface of the housing.

FIG. 3 depicts an assembly view of a power outlet that has a switch above the outlet body.

### DETAILED DESCRIPTION OF THE PREFERRED EMBODIMENTS

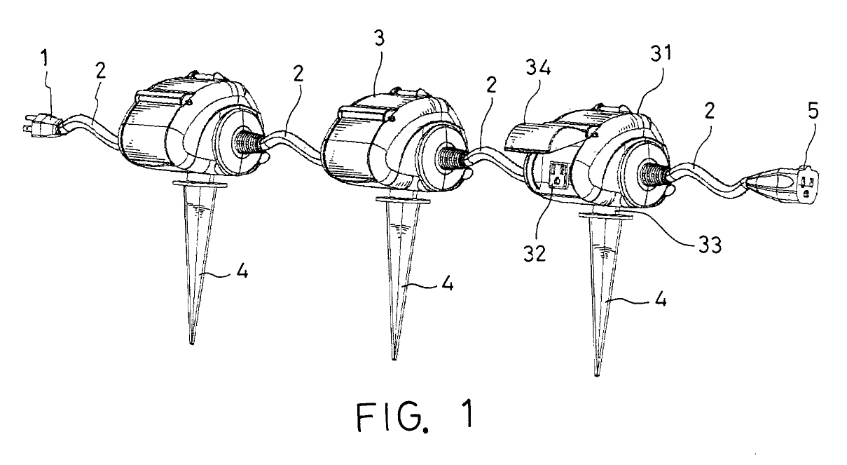

Referring first to FIG. 1 depicts an assembly view of a power outlet with support in accordance with one embodiment of the present invention. The power outlet with support comprises: a male plug 1; at least one wire 2; at least one outlet apparatus 3; and at least one support 4.

Wherein, the male plug 1 is coupled to an AC power source (not shown), such as, for example 110V or 220V AC power source. The wire 2 has at least two conductive wires, wherein one end of the wires is connected to said male plug I for getting said AC power source. The outlet apparatus 3 comprises a outlet 32 and a housing 31 that has a mating structure 33 on a lower surface, wherein the housing 31 is made of insulating materials, for example but not limited to plastic material. One end of the outlet apparatus 3 is connected to another end of the wire 2 and another end of the outlet apparatus 3 is connected to another wire 2 for connecting to next outlet 32 sequentially. The support 4 is configured in response to the mating structure 33 of said housing 31 for supporting and fixing said power outlet, wherein the shape of the support 4 is a triangle awl so as to make the user fixing said power outlet conveniently.

Referring again to FIG. 1, wherein the outlet apparatus 3 further comprises a cover 34 that covers over said outlet apparatus 3 so as to make the outlet apparatus 3 having ability to waterproof and dustproof for ensuring the conductivity of the outlet apparatus 3.

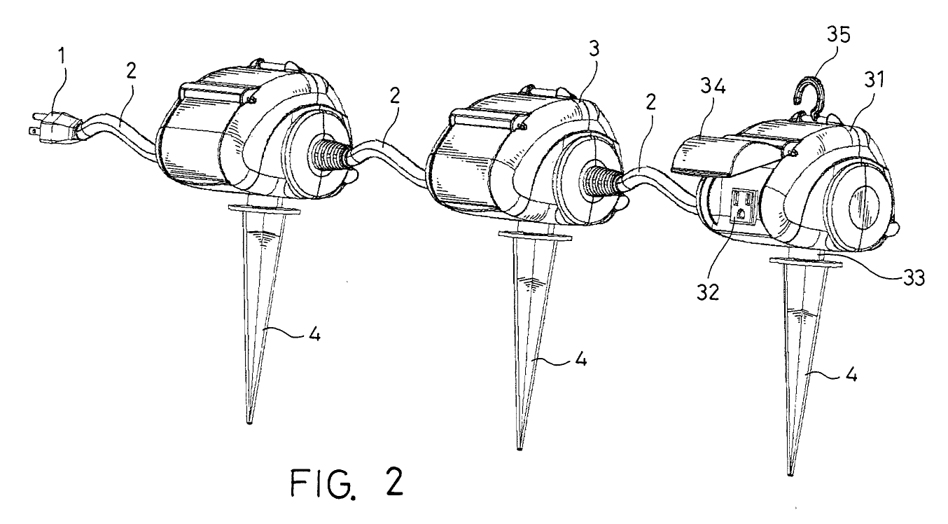

Referring to FIG. 2 depicts an assembly view of a power outlet that has a hook on the top surface of the housing. Wherein, the outlet apparatus 3 further comprises a hook 35 on the top surface of the housing 3 for fixing purpose. Besides the support 4, the outlet apparatus 3 could be hanged to a fence or a tree by the hook 35 for fixing purpose. In addition, one end of the last section of the wire 2 could be connected to an outlet 32 for extension the length of the power outlet.

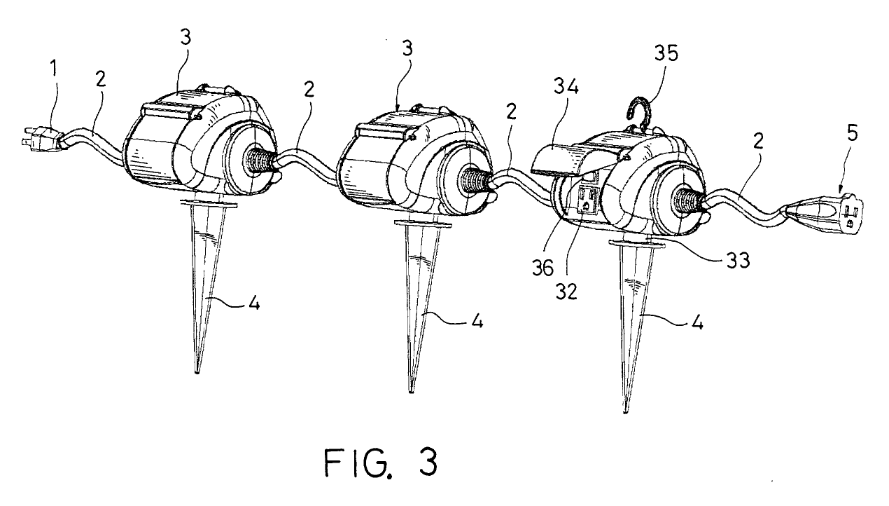

Referring to FIG. 3 depicts an assembly view of a power outlet that has a switch above the outlet body. As shown in FIG. 3, the outlet apparatus 3 further comprises a switch 36 above the outlet 32 for controlling the ON/OFF state of the power outlet 32. When the switch 36 turned off, the power would not provide to the outlet 32 for protecting the user who uses the power outdoor.

The description of the present invention has been presented for the purposes of illustration and description, but is not intended to be exhaustive or limited to the invention in the form disclosed. Many modifications and variations will be apparent to those of ordinary skill in the art. The embodiment was chosen and described to best explain the principles of the invention, the practical application, and to enable others of ordinary skill in the art to understand the invention for various embodiments with various modifications as suited to the particular use contemplated. While the invention has been described with reference to a preferred embodiment thereof, it is to be understood that modifications or variations may be easily made without departing from the spirit of this invention, which is defined by the appended claims.

What is claimed is:

1. A power outlet with support, comprising:
a male plug for coupling to a power source;
at least one wire having at least two conductive wires, wherein one end of the wire is connected to said male plug;
at least one outlet apparatus, wherein each outlet apparatus comprises a outlet and a housing that has a mating structure on a lower surface, one end of the outlet apparatus connected to another end of the wire and another end of the outlet apparatus connected to another wire; and
at least one support is configured in response to said mating structure of said housing for supporting and fixing said power outlet.

2. A power outlet with support as claimed in claim 1, wherein the outlet apparatus further comprises a switch for controlling said power source ON or OFF.

3. A power outlet with support as claimed in claim 1, wherein the outlet apparatus further comprises a cover that covers over said outlet apparatus so as to make said outlet apparatus having ability to waterproof and dustproof.

4. A power outlet with support as claimed in claim 1, wherein the support is in shape of a triangle awl.

5. A power outlet with support as claimed in claim 1, wherein the outlet apparatus further comprises a hook for fixing purpose.

6. A power outlet with support as claimed in claim 1, wherein the housing is an insulator preferably.

7. A power outlet with support as claimed in claim 1, wherein the last section of the wire further comprises an outlet.
